(19) United States
(12) Patent Application Publication
(10) Pub. No.: US 2008/0196414 A1
(43) Pub. Date: Aug. 21, 2008

(54) Strut cavity pilot and fuel injector assembly

(76) Inventors: Dean E. Andreadis, Palm Beach Gardens, FL (US); James D. Blevins, Palm Beach Gardens, FL (US); Stephen A. Beckel, Port Jefferson, NY (US)

Correspondence Address: BACHMAN & LAPOINTE, P.C. (P&W), 900 CHAPEL STREET, SUITE 1201, NEW HAVEN, CT, 06510-2802, US

(21) Appl. No.: 11/087,292

(22) Filed: Mar. 22, 2005

(51) Int. Cl. F02C 1/00

(52) U.S. Cl. 60/746

(57) ABSTRACT

A ramjet engine has an inlet, an outlet, and a gas flowpath from the inlet to the outlet. A pilot recess is along the flowpath. A plurality of struts extend within the flowpath. Each strut has first and second side surfaces extending between leading and trailing ends the trailing end sweeping away from the recess in a downstream direction across from the pilot recess. Each strut has first and second distributed fuel outlets positioned to discharge fuel from the first and second side surfaces respectively.

### US GOVERNMENT RIGHTS

The invention was made with U.S. Government support under contract NAS-01138 awarded by the National Aeronautics and Space Administration and under contract F33615-96-C-2694 awarded by the US Air Force. The US Government has certain rights in the invention.

### BACKGROUND OF THE INVENTION

The invention relates to dual mode (subsonic and supersonic combustion) ramjet engines (dual mode SCRAMJETs-DMSJ). More particularly, the invention relates to combustor piloting with primary and secondary fuel injection useable in such engines to initiate and propagate flame (e.g., in subsonic and supersonic combustion of hydrocarbon fuel).

An exemplary DMSJ engine has a forebody, internal inlet, isolator, combustor and exhaust nozzle. A DMSJ engine typically requires a pilot cavity and fuel injector assembly to initiate and propagate flame in the combustor for engine operability and performance. A common approach is to use an intrusive injector in conjunction with a cavity to produce sufficient flame stability for combustor operation during flight.

Various types of pilot cavity assemblies have been proposed. In one type, successful prior-art engine systems use a piloting scheme embedded in the combustor airflow path that is separately fueled and, subsequent to combustion of that fuel, delivers a high-temperature gaseous jet that is used to ignite additional hydrocarbon fuel delivered to the combustor. Drawbacks to this type of piloting scheme include scalability, mixing capability, high aerodynamic blockage (i.e., drag), high cost and complexity.

Owing to their geometric characteristics, the downward scalability of these devices is limited and their applicability in reduced-scale combustors is as yet undetermined. In reduced scale applications, the prior art devices present unacceptable levels of aerodynamic blockage and drag characteristics to the flow of air through the combustor.

### SUMMARY OF THE INVENTION

One aspect of the invention involves a ramjet engine has an inlet, an outlet, and a gas flowpath from the inlet to the outlet. A pilot recess is along the flowpath. A plurality of struts extend within the flowpath. Each strut has first and second side surfaces extending between leading and trailing ends the trailing end sweeping away from the recess in a downstream direction across from the pilot recess. Each strut has first and second distributed fuel outlets positioned to discharge fuel from the first and second side surfaces respectively.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a hypersonic or dual mode scramjet-powered aircraft.

FIG. 2 is a side longitudinal sectional view of a combustor of an engine of the aircraft of FIG. 1.

FIG. 3 is an upward longitudinal sectional view of the combustor of FIG. 2 taken along line 3-3.

FIG. 4 is a forward transverse sectional view of the combustor of FIG. 2, taken along line 4-4.

FIG. 5 is a side longitudinal sectional view of an alternate combustor.

FIG. 6 is a view of the combustor of FIG. 5 in an outwardly-shifted configuration.

FIG. 7 is a view of the combustor of FIG. 6 in a longitudinally-shifted configuration.

Like reference numbers and designations in the various drawings indicate like elements.

### DETAILED DESCRIPTION

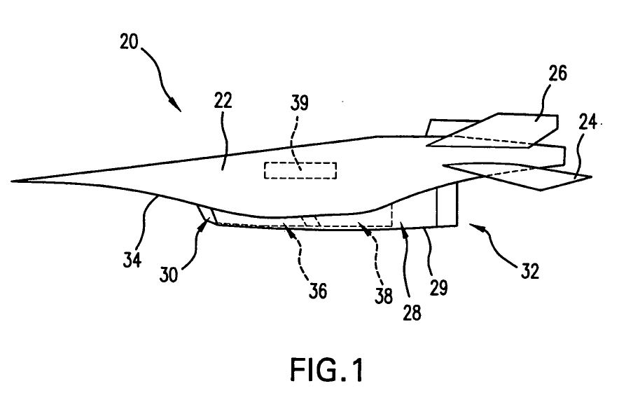

FIG. 1 shows a dual mode scramjet-powered aircraft 20 having a fuselage 22, a wing 24, and a tail assembly 26. A dual mode scramjet engine 28 is formed in a cowl 29 on an underside of the fuselage 22 and defines an air flowpath between a forward inlet/intake 30 and an aft outlet 32 (e.g., an exhaust nozzle). Along the flowpath, the engine may include a forebody 34, an isolator 36 (often integrated therewith), and a combustor 38. A control system 39 (optionally a portion of the aircraft's avionics) may control operation of the combustor 38 in response to one or more of sensor input, operator input, and the like. This configuration is merely exemplary.

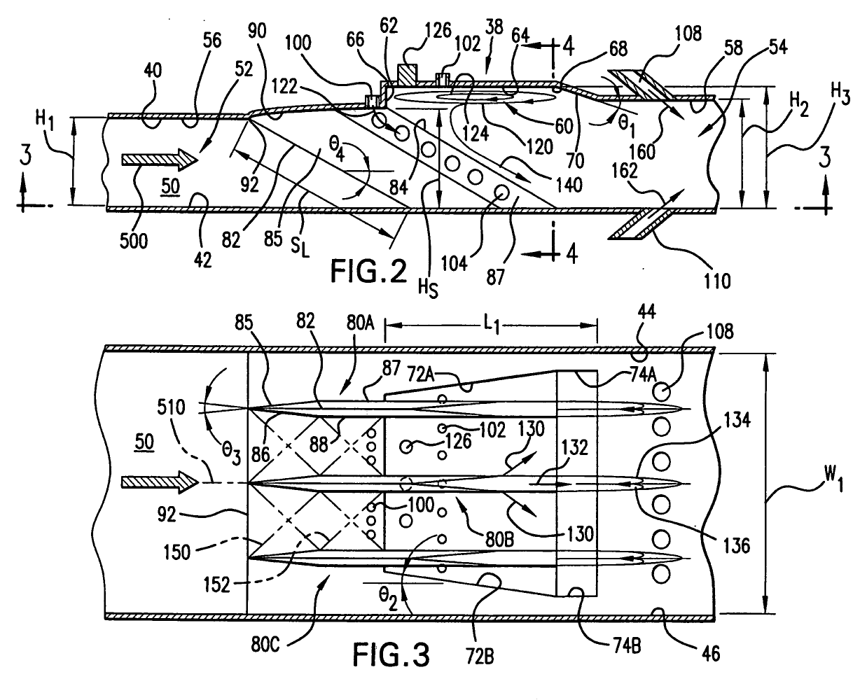

FIGS. 2-4 show a first exemplary combustor 38 for the engine 28. The exemplary combustor 38 has an upper wall 40, a lower wall 42, and a pair of sidewalls 44 and 46 (FIG. 3) and defining an airflow channel 50 which receives an airflow 500 passing through the inlet 30 in a downstream direction. In the exemplary aircraft, the upper wall 40 is on the fuselage side of the aircraft, while the lower wall 42 is on the cowl side.

In the exemplary engine, a region 52 of the channel 50 at an upstream end of the combustor has a smaller cross-sectional area than a region 54 at a downstream end. In the simplified exemplary engine, this difference may be characterized by an increase in the channel height or separation of the walls 40 and 42 from H₁ and H₂ while the channel width or spacing of the walls 44 and 46 is constant at W₁. Many other configurations are possible. For ease of reference, in the exemplary engine, the upper wall 40 has a first flat portion 56 at and generally upstream of the combustor and a second flat portion 58 at and extending generally downstream of the combustor.

The combustor 38 includes a pilot recess or cavity 60. In the exemplary combustor, the cavity 60 is centrally positioned and, at least partially along its length L₁, extends only partially across the width of the channel 50. In the exemplary combustor, the cavity 60 is formed generally within an otherwise intact area of the wall portion 58. The exemplary cavity 60 has a leading/upstream wall 62 extending generally transverse to the overall downstream direction. A base wall 64 extends downstream from an essentially right angle junction 66 with the upstream wall 62 to an obtuse intersection 68 with a trailing/downstream wall 70. The exemplary base wall 64 is essentially locally parallel to and spaced apart from the lower wall 42 by separation H₃. The exemplary downstream wall 70 extends at a shallow angle θ₁ to the overall downstream direction (e.g., 10-40°). The exemplary cavity 60 has a pair of sidewalls each characterized by an upstream portion 72A; 72B and essentially longitudinally coextensive with the base wall 64 and by a downstream portion 74A; 74B essentially longitudinally coextensive with the downstream wall 70. In the exemplary cavity, the upstream portions 72A and 72B are slightly downstream divergent by an angle θ₂ relative to the overall downstream direction (e.g., 5-20°) and the portions 74A and 74B are essentially downstream/longitudinally-extending.

The combustor further includes a number of struts 80A, 80B, and 80C. In the exemplary combustor, the struts are identical in size/shape and transversely arrayed at an identical longitudinal position. Each of the struts has a leading extremity 82 (FIG. 2) and a trailing extremity 84. In the exemplary strut, the leading extremity 82 is a sharp corner edge and the trailing extremity 84 is a flat transversely-extending facet. Downstream from the leading extremity 82, first and second sides of the strut include facets 85 and 86 (FIG. 3) forming a wedge shape. The exemplary facets extend for approximately half the streamwise span of the struts, intersecting with downstream facets 87 and 88. In the exemplary embodiment, the facets 85 and 86 of each strut are divergent from each other by an angle θ₃ while the downstream facets 87 and 88 are parallel to each other. In the exemplary struts, a centerplane 510 extends longitudinally.

Because the presence of the struts might otherwise unacceptably decrease the available cross-sectional area for the airflow 500, the upper wall 40 includes a concave, downstream-divergent, portion 90 between the portion 56 and the cavity 60 creating an area rule effect to at least partially compensate for the loss of cross-sectional area presented by the struts. In the exemplary combustor, the portion 90 extends from a leading intersection 92 with the portion 56 downstream to the longitudinal position of the cavity leading wall 62. In the exemplary combustor, the struts have an essentially constant section swept downstream away from the upper wall 40 at an angle θ₄ to the downstream/longitudinal direction. The sweep places the downstream extremity/facet 84 in generally facing relationship to the cavity 60.

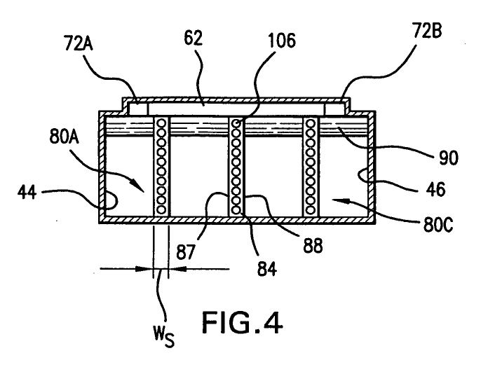

The struts may be distinguished from other features such as ramps which direct airflow principally over an end of the ramp rather than around sides of the ramp. Thus, struts which extend less than entirely across the channel are possible. FIG. 2 shows the strut having a maximum height H_{S} (from the trailing edge of the strut first end at the surface 90 to the wall 42 in the exemplary strut). Other characteristic heights (including means, medians, and modes) are possible. FIG. 2 further shows the strut as having a leading edge span S_{L} (a trailing edge span being slightly greater than the exemplary embodiment). FIG. 4 shows the strut as having a width W_{S} between its side surfaces 87 and 88. In the exemplary strut, this dimension represents the maximum width at each spanwise location. Other characteristic widths (including means, medians, and modes) are possible. Relative to ramp-like structures exemplary struts have higher ratios of characteristic height to characteristic width. Exemplary maximum height to median spanwise width ratios are in excess of 2, 3, or 4 to 1.

Fuel may be introduced to the combustor at a variety of locations and for a variety of purposes. The exemplary combustor includes pilot fuel injectors, primary main fuel injectors, and secondary main fuel injectors. These may all draw fuel from a common source. The exemplary pilot fuel injectors are located in two groups. A first group of pilot fuel injectors 100 is positioned upstream of the cavity 60 (e.g., transversely arrayed relatively downstream along the surface portion 90). A second group of pilot fuel injectors 102 is positioned to introduce fuel within the cavity 60 (e.g., positioned relatively upstream along the base wall 64 in a transversely extending array). In the exemplary combustor, the primary main fuel injectors are positioned along the struts. These may include a spanwise array of injectors 104 along each of the facets 87 and 88 (FIG. 2) and 106 along the downstream/trailing facet/extremity 84 (FIG. 4). The secondary main fuel injectors may include first and second transversely-extending arrays of injectors 108 and 110 respectively positioned on the walls 40 and 42 downstream of the cavity 60.

In the exemplary combustor, the cavity 60 is shaped to provide a recirculation 120 within the cavity. The recirculation includes air diverted from the airflow and pilot fuel from streams 122 and 124 discharged from the injectors 100 and 102. The recirculation mixes this pilot fuel with the air and exposes the mixture to igniters 126 (e.g., a transverse array of igniters in the cavity base wall 64 just downstream of the cavity leading wall 62). The sweep of the sidewall upstream portions 72A and 72B helps provide additional air entrainment within the cavity 60. In an alternative version of this basic engine, to maximize the cavity volume and cavity flow residence time, the cavity may extend essentially entirely across the transverse span of the channel and/or its sidewalls may be unswept. Even with the exemplary cavity and strut configuration, other pilot injector arrangements are possible including arrangements having only the injectors within the cavity and only the injectors outside of the cavity. The upstream location of the injectors 100 provides for enhanced mixing of the pilot fuel and air prior to encountering the cavity.

The injectors 104 discharge fuel streams 130 and the injectors 106 discharge fuel streams 132 from the struts. In the exemplary engine, the transversely-extending bluff configuration of the downstream facet/extremity 84 helps provide each strut with a pair of trailing recirculation zones 134 and 136 for mixing of fuel from the streams 130 and especially 132 with air. The strut sweep and proximity to the cavity 60 helps place the fuel from the streams 130 and 132 in effective proximity to the combusting pilot fuel in the recirculation 120 so that the burning flame of pilot fuel (schematically shown as 140) exiting the cavity 60 is positioned to maintain ignition of the primary main fuel. In addition to this drafting of pilot flame from the cavity, the sweep of the struts permits a broader spatial distribution of the primary main fuel across essentially the entire height and width of the channel. Additionally, the swept struts' leading edges 82 generate oblique shock waves 150 and 152 along the streamwise direction which form compression waves between the struts. The compression waves induce the establishment of static pressure in which ignition of the fuel and air mixture within the cavity can occur. Nevertheless, other configurations for the primary main fuel injectors are possible, including different injection arrangements along the different struts, asymmetric arrangements along each strut, and the like and even non-strut injection. For example, if the fuel flow from the strut sides is sufficient, the injectors 106 may be omitted.

The secondary main fuel injectors 108 and 100 discharge fuel streams 160 and 162 downstream of the cavity 60. The streams 160 and 162 encounter the airflow at a point where the primary main fuel has already begun to combust across essentially the entirety of the transverse area of the channel. The secondary main fuel injectors may be operated in conjunction with the primary main fuel injectors and pilot fuel injectors to accommodate engine operation and mode transition via fuel staging. For example, fuel injectors 100 and 108 are distributing the fuel between the struts in front and aft of the cavity, respectively. In addition fuel injector 100 provides fuel to the airflow that is entrained into the cavity while injector 108 accommodates engine fuel staging requirements which controls shock train location and thus prevents combustor inlet interaction. An exemplary percentage breakdown of the overall mass flow rate of the fuel is about 15% (e.g., more broadly, 10-25%) for the pilot injectors, 30% (e.g., 20-50% for the primary main fuel injectors, and 55% (e.g., 30-65) % for the secondary main fuel injectors. As the engine operates at higher Mach number the fuel will be staged forward in the engine and distributed between the pilot, primary and secondary injectors.

The area rule effect provided by the surface portion 90 also serves to improve the ability to stabilize any pre-combustion shock train induced by the downstream combustion process. Advantageously, however, the cavity leading wall 62 has sufficient height so that flow passing downstream from the downstream extremity of the surface 90 passes clear of the cavity downstream surface 70. For example, the junction of leading wall 62 with the surface portion 90 may be slightly closer to the lower wall 42 than is the junction of the trailing wall 70 with the wall portion 58. This prevents overheating of the cavity downstream surface 70.

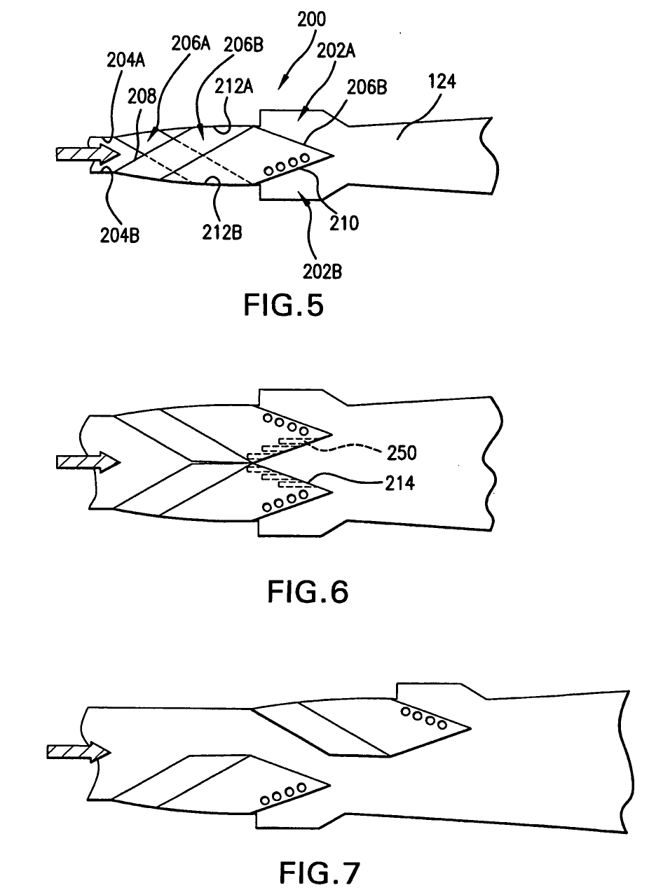

In the combustor of FIGS. 2-4, there is a pilot cavity along a single side of the channel with all the struts having a similar relationship to that cavity. Other configurations are possible. Even within the basic examples of combustors extending generally symmetrically laterally across a flow channel, other configurations are possible. FIG. 5 shows a combustor 200 having first and second pilot cavities 202A and 202B in opposed first and second walls 204A and 204B. For example, in the basic aircraft 20, one of the walls 204A or 204B may be on the fuselage side and the other may on the cowl side. The combustor has a transverse array of alternating struts 206A and 206B. Each strut has a leading extremity 208 and a trailing extremity 210. Each strut extends from a first end at an associated surface 212A or 212B upstream of the associated pilot cavity. At the second end, the strut leading wedge meets the opposite surface 212B or 212A. As is discussed below, the struts may be rigidly mounted to the adjacent wall at their first ends and may either be rigidly mounted to the adjacent wall at their second ends or the second ends may be free. With the exemplary struts, however, the constant thickness downstream portion of the strut, however, terminates in an end face 214 facing the opposite pilot cavity. Other configuration details as well as operation details of the combustor 200 may be similar to those of the combustor 38.

If, for example, the strut second ends are free, it may be possible to shift the walls (i.e., vertical or longitudinal cowl translation) 204A and 204B and their associated struts and cavities relative to each other responsive to vehicle operating conditions and performance aspects of the engine. Movements such as inlet flap rotation and cowl translation may be performed by actuators (not shown) under control of the control system 39 to control engine mass capture and contraction ratio (e.g., to control vehicle thrust and specific impulse in flight). The control system 39 may be programmed by one or both of hardware and software to actuate the movement in response to one or a combination of sensed parameters (e.g., engine operational parameters and aircraft flight parameters) and user input (e.g., on-board crew, remote crew, or programmed flight plan).

Such cowl movement may include a translation apart (e.g., to, through, or beyond the exemplary position of FIG. 6). A separation increase or decrease may be effective to vary performance aspects of the engine by increasing or decreasing airflow as well as contraction ratio. Flight vehicle thrust demand and required acceleration at specified Mach number, angle-of-attack, and dynamic pressure may be determined through aircraft control sensed parameters. Based upon such sensed parameters, the engine control system may specify engine inlet flap rotation and cowl translation. In an exemplary operation, if the vehicle is climbing and requires additional acceleration in flight, the control system may increase fuel flow (throttle up to maximum equivalence ratio), increase engine airflow (increase thrust) via outward cowl translation, and rotate the inlet flap to achieve maximum contraction ratio and maximum specific impulse (ISP). These parameters can be set by the control system until vehicle thrust demand is satisfied with maximum ISP.

The movement may also include a relative longitudinal cowl translation (e.g., toward, to, or beyond the relative position of FIG. 7 which already reflects the separation change of FIG. 6). Such a longitudinal translation may be effective to vary performance aspects of the engine by increasing or decreasing airflow and contraction ratio as well as more advantageously staging cowl strut and cavity fuel along the flight trajectory. For example, in an exemplary operational sequence, the engine operation begins with the cowl at the most aft position and it moves forward or aft to accommodate vehicle thrust requirements. With the cowl at the most aft position, the inlet is set at the starting contraction ratio (lowest contraction ratio) and allows the engine to receive maximum airflow with lowest vehicle drag characteristics and reduced nozzle over-expansion. The cowl translates forward as the vehicle continues to accelerate through a specified trajectory and controls airflow and contraction ratio as required.

If no fueling changes are made, then effecting the positional changes of the combustor 200 may cause fueling imbalances. For example, a central region of the channel between the wall 204A and 204B may become relatively fuel-depleted or lean. Various physical configurations and operational changes may accommodate this. For example, the struts may have injectors 250 along the end face 214. As the separation increases, a fuel flow through these injectors 250 may also be increased to maintain a desired fuel distribution across the channel. Alternatively, or additionally, further injectors could be located along the sides of the struts adjacent the end faces 214 and similarly fueled in conjunction with the separation changes.

One or more embodiments of the present invention have been described. Nevertheless, it will be understood that various modifications may be made without departing from the spirit and scope of the invention. For example, the principles may be applied to a variety of existing or yet-developed engine and vehicle configurations. Accordingly, other embodiments are within the scope of the following claims.

What is claimed is:

1. A ramjet engine comprising:
an inlet;
an outlet;
a gas flowpath from the inlet to the outlet;
a pilot recess along the flowpath; and
a plurality of struts extending within the flowpath and each comprising:
first and second side surfaces extending between leading and trailing ends the trailing end sweeping away from the recess in a downstream direction across from the pilot recess; and
first and second distributed fuel outlets positioned to discharge fuel from the first and second side surfaces respectively.

2. The engine of claim 1 wherein:
there no additional struts in the flowpath; and
for each of the struts:
the leading end is essentially a line edge; and
the trailing end is essentially a transverse face.

3. The engine of claim 1 wherein:
each of the struts has a median width and a median height at least three times the median width.

4. The engine of claim 1 wherein each of the struts further comprises:
a third distributed fuel outlet positioned to discharge fuel from the trailing end.

5. The engine of claim 4 wherein:
for each of the struts:
the first, second, and third distributed fuel outlets each comprise a distributed plurality of discrete outlets; and
the first and second distributed fuel outlets are along essentially parallel downstream portions of the first and second surfaces, respectively.

6. The engine of claim 1 wherein:
the pilot recess is a first pilot recess;
the plurality of struts is a plurality of first struts;
the engine further comprises:
a second pilot recess along the flowpath; and
a plurality of second struts extending within the flowpath and each comprising:
first and second side surfaces extending between leading and trailing ends the trailing end sweeping away from the recess in a downstream direction across from the second pilot recess; and
first and second distributed fuel outlets positioned to discharge fuel from the first and second side surfaces respectively.

7. The engine of claim 6 wherein the plurality of first struts and the first recess are movable relative to the plurality of second struts and the second recess.

8. The engine of claim 7 further comprising a control system programmed to actuate movement of the plurality of first struts and the first recess are relative to the plurality of second struts and the second recess in response to one or more of:
sensed flight parameters;
sensed engine operational parameters; and
command inputs.

9. The engine of claim 6 wherein the plurality of first struts and the first recess are movable relative to the plurality of second struts and the second recess:
at least partially longitudinally; and
at least partially transversely toward and away from each other.

10. A combustion apparatus comprising:
means for discharging a pilot fuel;
a cavity providing a recirculation region for the mixing of air with the pilot of fuel; and
a plurality of struts, each having:
leading and trailing extremities;
means for discharging a strut fuel downstream;
means for providing a recirculation region of an airflow over the strut for mixing the airflow with the strut fuel; and
means for providing a drafting of flame from the cavity.

11. The apparatus of claim 10 wherein the means for discharging include a plurality of fuel outlets along the trailing extremity of each strut.

12. The apparatus of claim 10 wherein each of the struts has a median width and a median height at least three times the median width.

13. The apparatus of claim 10 wherein each of the struts has a section characterized by:
a leading wedge; and
a straight transverse trailing extremity.

14. The apparatus of claim 10 wherein each of the struts has a section characterized by:
an acute isosceles triangle having a smallest vertex angle at the leading extremity; and
a rectangle having a first smaller side at the base of the triangle and a second smaller side at the trailing extremity.

15. The apparatus of claim 10 wherein the cavity has first and second downstream divergent sidewalls.

16. The apparatus of claim 10 wherein leading portions of the struts are positioned to generate oblique shock waves forming compression waves between the struts.

17. The apparatus of claim 10 wherein a downstream divergent surface portion upstream of the cavity provides an area rule effect, compensating for flow blockages created by the struts.

18. The apparatus of claim 10 further comprising:
pilot fuel injectors upstream of a middle of the cavity; and
additional fuel injectors downstream of the cavity.
